(19) United States
(12) Patent Application Publication
(10) Pub. No.: US 2024/0070481 A1
(43) Pub. Date: Feb. 29, 2024

(54) CONFIGURING OPTIMIZATION PROBLEMS

(71) Applicant: INTERNATIONAL BUSINESS MACHINES CORPORATION, Armonk, NY (US)

(72) Inventors: Michael BARRY, Limerick City (TF); Joern PLOENNIGS, Dublin (IE); John SHEEHAN, Dublin (IE); Claudio GAMBELLA, Phibsborough (IE)

(73) Assignee: INTERNATIONAL BUSINESS MACHINES CORPORATION, Armonk, NY (US)

(21) Appl. No.: 17/822,698

(22) Filed: Aug. 26, 2022

(51) Int. Cl. G06N 5/02; G06F 40/295; G06N 5/04

(52) U.S. Cl. CPC G06N 5/022; G06F 40/295; G06N 5/045

(57) ABSTRACT

Various embodiments are provided for configuring optimization problems from one or more sources in a computing environment by a processor. A knowledge graph may be generated from a knowledge domain and one or more data sources. One or more graph pattens may be applied to match one or more entities in the knowledge graph with one or more atomic optimization templates. An optimization problem configured from the one or more atomic optimization templates and a plurality of data may be executed.

### BACKGROUND

The present invention relates in general to computing systems, and more particularly, to various embodiments for configuring optimization problems from sensor lists/knowledge graphs using a computing processor.

### SUMMARY

According to an embodiment of the present invention, a method for configuring optimization problems from one or more sources in a computing environment, by one or more processors, in a computing system. A knowledge graph may be generated from a knowledge domain and one or more data sources. One or more graph pattens may be applied to match one or more entities in the knowledge graph with one or more atomic optimization templates. An optimization problem configured from the one or more atomic optimization templates and a plurality of data may be executed.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

Thus, in addition to the foregoing exemplary method embodiments, other exemplary system and computer product embodiments are provided.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention.

FIG. 2 is an additional block diagram depicting an exemplary cloud computing environment according to an embodiment of the present invention.

FIG. 3 is an additional block diagram depicting abstraction model layers according to an embodiment of the present invention.

FIG. 4 is an additional block diagram depicting various user hardware and cloud computing components functioning in accordance with aspects of the present invention.

FIG. 5 is a block flow diagram depicting operations for configuring optimization problems from one or more sources in which aspects of the present invention may be realized.

FIG. 6 is an additional block diagram construction of a knowledge graph in accordance with aspects of the present invention.

FIG. 7 is an additional block diagram applying graph patterns to match entities from the knowledge graph in accordance with aspects of the present invention.

FIG. 8 is an additional block diagram illustrating an example of a resulting pipeline configuration of the optimization problem in accordance with aspects of the present invention.

FIG. 9 is an additional block diagram adding additional data in accordance with aspects of the present invention.

FIG. 10 is an additional block diagram using an external solver to run a model in accordance with aspects of the present invention.

FIG. 11 is an additional block diagram explaining optimization results using a knowledge graph in accordance with aspects of the present invention.

FIG. 12 is a flowchart diagram depicting an exemplary method for identifying relevant graph patterns in a knowledge graph in a computer environment in which aspects of the present invention may be realized.

### DETAILED DESCRIPTION OF THE DRAWINGS

The present invention relates generally to knowledge graph databases in a computing environment. In knowledge graph databases, stored information is represented by means of a knowledge graph which has nodes interconnected by edges. Nodes of the graph represent entities for which entity data, characterizing those entities, is stored in the database. Entities may, for example, correspond to people, companies, devices, etc. More generally, nodes may represent any entity (real or abstract) for which information needs to be stored. The entity data stored for a node may comprise one or more data items, often called “properties” or “property values”, describing particular features of an entity. Edges of the graph represent relationships between entities. An edge connecting two nodes of the graph represents some defined relationship which is applicable to the entities represented by those nodes. A graph may accommodate different relationships between entities, with each edge having a specified type, indicated by an edge name or “label”, signifying the particular relationship represented by that edge. Nodes may also have associated names, or labels, to indicate different types or categories of node corresponding to different entity-types represented in the graph.

Knowledge graphs provide highly efficient structures for representing large volumes of diverse information about interrelated entities. Querying a knowledge graph database involves formulating a query request defining the information needed from the database in such a way that relevant nodes, edges, and properties can be identified, and then following edges in the graph to identify and extract the required data from storage. Knowledge graphs can be conveniently represented using matrices in which non-zero entries signify edges and row, and column indices correspond to node identities. The process of identifying and extracting data for a query request can be implemented by performing mathematical operations on such matrices.

However, one of the challenges is the configuration of complex optimization scenarios from sensor lists using customized use case constraints. Currently there is no easy way to configure complex optimization scenarios to custom use case constraints. Practical applications of optimization in highly customized business solutions is often challenging as it is hard to address the need to map these customizations into custom constraints in a predefined optimization solution. This results in huge scalability issues of configuring optimization solutions which either results in highly specialized solution which do not address all practical needs or generalized frameworks that require an optimization expert to work with.

Thus, a needs exists to provide a solution to configure optimization problems form sensor list/graphs. Accordingly, the present invention provides novel solutions to compose optimization problems from a list of sensors and system components through the application of graph patterns. The present invention employs a semantic knowledge graph that encodes 1) a set of set of sensors and system components and their causal relationships, 2) a domain knowledge including optimization problems that are applicable to the domain.

The present invention identifies and uses graph patterns that select entities for inclusion in the optimization problem such as, for example, uses templates associated with the graph patterns that capture a component piece of the optimization problem. The present invention uses datasets linked to the semantic graph to populate a scoring dataset for the optimization problem. An optimization solver is provided to execute the optimization problem and the graph patterns are used to explain the results. In one aspect, a graph pattern is a search template formulated as a sub-graph that, when executed on a knowledge graph, returns a list of entities in the knowledge graph that match the pattern. The entities can then be used as inputs to functions or processes relevant to the optimization problem such as populating problem constraints.

In some implementations, the present invention provides for reasoning operations to generate a knowledge graph from one or more sensor or system components lists. A selection of instances may be applied to an optimization problem using a library of optimization graph patterns (e.g., a discovery phase). That is, one or more potential instances and entities may be discovered for use in an optimization solution using a library of optimization graph patterns.

A population of an optimization problem using extended configuration patterns stored in a library of graph patterns may be used. That is, the present invention provides for a population of the optimization problem including custom constraints using atomic optimization templates associated with the graph patterns. In some implementations, the present invention provides for the transformation of the graph patterns into a formulaic description of the optimization problem including custom constraints via attribute query patterns (e.g., a transformation phase). In some implementations, the present invention provides for the configuration of the optimization scenarios using data queries against datasets linked in the graph. An instantiation of multiple, specific optimization scenarios may be provided by running data queries against datasets linked in the graph. One or more explanation of the results of the optimization and periodization of results are provided using the relationships and constraints given in the respective graph pattern.

In other implementations, the present invention provides for a system and associated methods for automatic configuration, execution and explanation of an optimization algorithm. In one aspect, the present invention may receive as input: a) domain knowledge, b) a set of sensors and system components, c) datasets related to the sensors and system, and d) a library of pre-defined graph patterns and associated atomic optimization templates. The present invention may analyze and process the received input data. The present invention may use a) a semantic knowledge graph to encode the entities and their relationships, b) graph patterns that select potential entitles to populate an instantiation of a domain optimization problem using the related datasets, c) an external optimization engine to execute the optimization problem, and d) graph patterns to explain the optimization solution.

In some implementations, the present invention configures, generates, and explains an optimization problem using graph patterns by 1) discovering entities in a knowledge graph that apply to the given optimization problem including custom constraints. The discovery operation uses pre-defined graph patterns and reasoning to extract entities from the graph. The entities are applied to populate atomic optimization templates and are used to configure an atomic subset of an optimization problem.

In some implementations, the present invention configures, generates, and explains an optimization problem using graph patterns by 2) composing a larger optimization problem using the discovered entities along optimization pipelines defined in the graph. The present invention takes the atomic optimization templates from a discovery component and composes them into a larger optimization scenario. It includes resolution of potential conflicts including mapping of variables that are used across multiple constraints and variable definition and visibility across the optimization pipeline.

In some implementations, the present invention configures, generates, and explains an optimization problem using graph patterns by 3) using a generator to combine additional data from datasets linked to the knowledge graph to formulate the optimization problem.

In some implementations, the present invention configures, generates, and explains an optimization problem using graph patterns by 4) explaining the optimization results using the knowledge graph patterns.

In general, as used herein, “optimize” may refer to and/or defined as “maximize,” “minimize,” or attain one or more specific targets, objectives, goals, or intentions. Optimize may also refer to maximizing a benefit to a user (e.g., maximize a trained machine learning pipeline/model benefit). Optimize may also refer to making the most effective or functional use of a situation, opportunity, or resource.

Additionally, optimizing need not refer to a best solution or result but may refer to a solution or result that “is good enough” for a particular application, for example. In some implementations, an objective is to suggest a “best” combination of preprocessing operations (“preprocessors”) and/or machine learning models/machine learning pipelines, but there may be a variety of factors that may result in alternate suggestion of a combination of preprocessing operations (“preprocessors”) and/or machine learning models yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

It should be noted as described herein, the term “intelligent” (or “intelligence”) may be relating to, being, or involving conscious intellectual activity such as, for example, thinking, reasoning, or remembering, that may be performed using a machine learning. In an additional aspect, intelligent or “intelligence” may be the mental process of knowing, including aspects such as awareness, perception, reasoning and judgment. A machine learning system may use artificial reasoning to interpret data from one or more data sources (e.g., sensor-based devices or other computing systems) and learn topics, concepts, and/or processes that may be determined and/or derived by machine learning.

In an additional aspect, intelligent or “intelligence” may refer to a mental action or process of acquiring knowledge and understanding through thought, experience, and one or more senses using machine learning (which may include using sensor-based devices or other computing systems that include audio or video devices). Intelligent or “intelligence” may also refer to identifying patterns of behavior, leading to a “learning” of one or more events, operations, or processes. Thus, the intelligent or artificial intelligence “AI” model may, over time, develop semantic labels to apply to observed behavior and use a knowledge domain or ontology to store the learned observed behavior. In one embodiment, the system provides for progressive levels of complexity in what may be learned from the one or more events, operations, or processes.

In additional aspect, the term intelligent or “intelligence” may refer to an intelligent system. The intelligent system may be a specialized computer system, or set of computer systems, configured with hardware and/or software logic (in combination with hardware logic upon which the software executes) to emulate human cognitive functions. These intelligent systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. An intelligent system may perform one or more computer-implemented cognitive operations that approximate a human thought process while enabling a user or a computing system to interact in a more natural manner. An intelligent system may comprise artificial intelligence logic, such as natural language processing (NLP) based logic, for example, and machine learning logic, which may be provided as specialized hardware, software executed on hardware, or any combination of specialized hardware and software executed on hardware. The logic of the cognitive system may implement the cognitive operation(s), examples of which include, but are not limited to, question answering, identification of related concepts within different portions of content in a corpus, and intelligent search algorithms, such as Internet web page searches.

In general, such intelligent systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and cognition; 10) Identify resonating, human-like attributes and traits from natural language; 11) Deduce various language specific or agnostic attributes from natural language; 12) Memorize and recall relevant data points (images, text, voice) (e.g., a high degree of relevant recollection from data points (images, text, voice) (memorization and recall)); and/or 13) Predict and sense with situational awareness operations that mimic human cognition based on experiences.

It should be noted that one or more computations or calculations may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

Other examples of various aspects of the illustrated embodiments, and corresponding benefits, will be described further herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

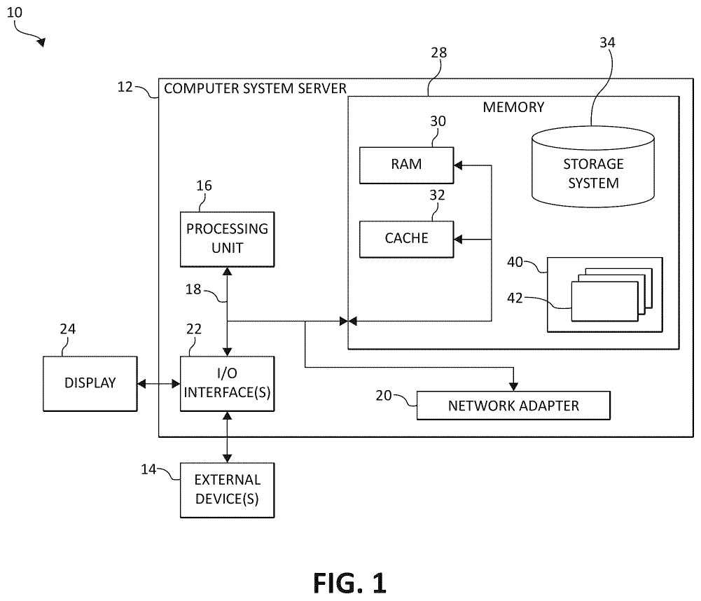

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

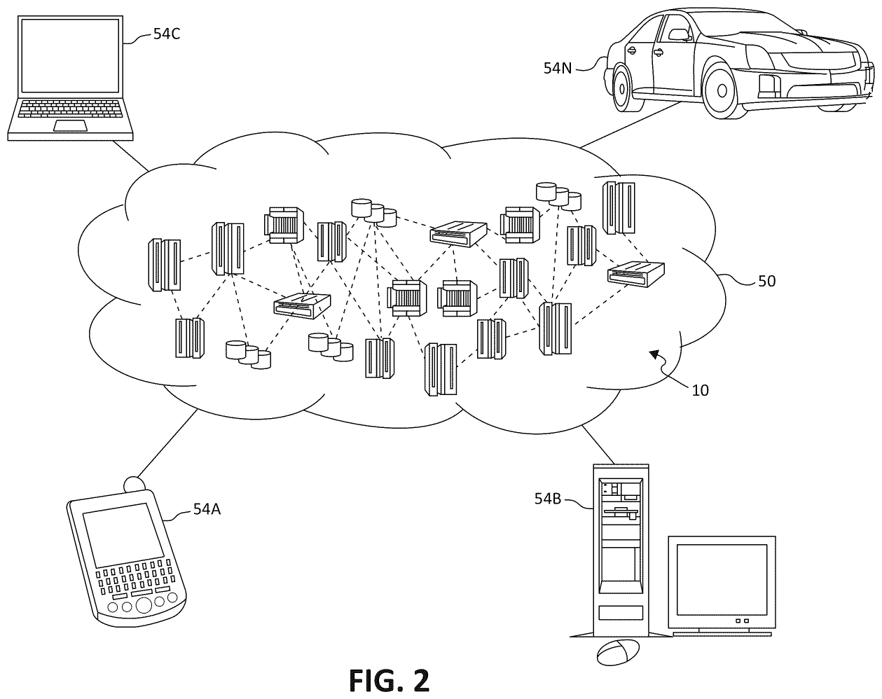

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

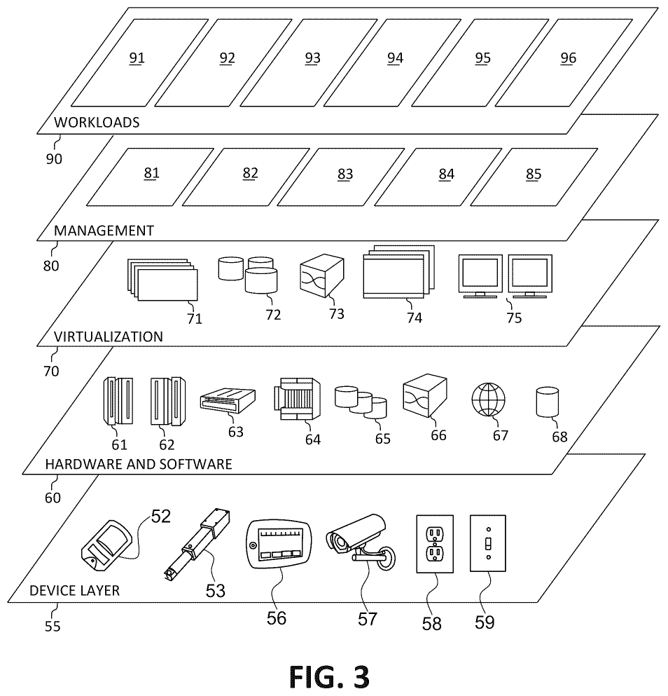

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for configuring optimization problems from one or more sources. In addition, workloads and functions 96 for configuring optimization problems from one or more sources may include such operations as data analytics, data analysis, and as will be further described, notification functionality. One of ordinary skill in the art will appreciate that workloads and functions 96 for configuring optimization problems from one or more sources may also work in conjunction with other portions of the various abstraction layers, such as those in hardware and software 60, virtualization 70, management 80, and other workloads 90 (such as data analytics processing 94, for example) to accomplish the various purposes of the illustrated embodiments of the present invention.

Thus, as described herein, in various implementation, the present disclosure provides for configuring optimization problems from one or more sources. In some implementations, a knowledge graph may be generated from a knowledge domain and one or more data sources. One or more graph pattens may be applied to match one or more entities in the knowledge graph with one or more atomic optimization templates. An optimization problem configured from the one or more atomic optimization templates and a plurality of data may be executed.

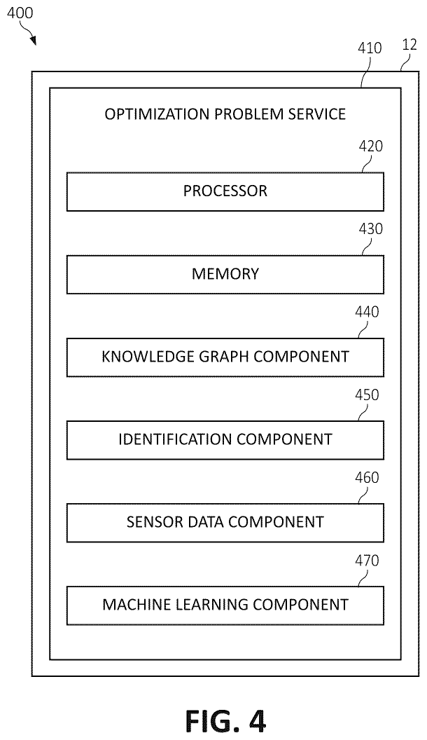

Turning now to FIG. 4, a block diagram depicting exemplary functional components of system 400 for configuring optimization problems from one or more sources in a computing environment according to various mechanisms of the illustrated embodiments is shown. In one aspect, one or more of the components, modules, services, applications, and/or functions described in FIGS. 1-3 may be used in FIG. 4. As will be seen, many of the functional blocks may also be considered “modules” or “components” of functionality, in the same descriptive sense as has been previously described in FIGS. 1-3.

In one aspect, the computer system/server may provide virtualized computing services (i.e., virtualized computing, virtualized storage, virtualized networking, etc.) to the intelligent conversational agent management and interaction service 402 and the conversation agent 404. More specifically, the computer system/server 12 may provide virtualized computing, virtualized storage, virtualized networking and other virtualized services that are executing on a hardware substrate.

An optimization problem service 410 is shown, incorporating processing unit 420 (“processor”) to perform various computational, data processing and other functionality in accordance with various aspects of the present invention. In one aspect, the processor 420 and memory 430 may be internal and/or external to the optimization problem service 410, and internal and/or external to the computing system/server 12. The optimization problem service 410 may be included and/or external to the computer system/server 12, as described in FIG. 1. The processing unit 420 may be in communication with the memory 430. The optimization problem service 410 may include a knowledge graph component 440, an identification component 450, a sensor data component 460, and a machine learning component 470.

In one aspect, the system 400 may provide virtualized computing services (i.e., virtualized computing, virtualized storage, virtualized networking, etc.). More specifically, the system 400 may provide virtualized computing, virtualized storage, virtualized networking and other virtualized services that are executing on a hardware substrate.

In some implementation, the optimization problem service 410, using the knowledge graph component 440, the identification component 450, the sensor data component 460, and/or the machine learning component 470, may generate a knowledge graph from a knowledge domain and one or more data sources; apply one or more graph pattens to match one or more entities in the knowledge graph with one or more atomic optimization templates; and execute an optimization problem configured from the one or more atomic optimization templates and a plurality of data.

The optimization problem service 410, using the knowledge graph component 440, the identification component 450, the sensor data component 460, and/or the machine learning component 470, may identify the one or more entities in the knowledge graph using the one or more graph patterns and reasoning data, wherein the one or more graph patterns are predefined.

The optimization problem service 410, using the knowledge graph component 440, the identification component 450, the sensor data component 460, and/or the machine learning component 470, may populate the one or more atomic optimization templates with the one or more entities; and configure an atomic subset of the optimization problem with the one or more entities.

The optimization problem service 410, using the knowledge graph component 440, the identification component 450, the sensor data component 460, and/or the machine learning component 470, may compose the optimization problem using the one or more entities identified in one or more optimization pipelines in the knowledge graph, wherein data linked to the knowledge graph is used to formulate the optimization problem.

The optimization problem service 410, using the knowledge graph component 440, the identification component 450, the sensor data component 460, and/or the machine learning component 470, may provide an optimized solution upon executing the optimization problem.

The optimization problem service 410, using the knowledge graph component 440, the identification component 450, the sensor data component 460, and/or the machine learning component 470, may configure an optimization problem using the one or more atomic optimization templates of a plurality of data.

The optimization problem service 410, using the knowledge graph component 440, the identification component 450, the sensor data component 460, and/or the machine learning component 470, may provide an explanation of results generated from executing the optimization problem.

In some implementations, the machine learning component 470 and/or the knowledge graph component 440 may include a library and/or a knowledge domain, which may be an ontology of concepts representing a domain of knowledge. A thesaurus or ontology may be used as the knowledge domain. In one aspect, the term “domain” is a term intended to have its ordinary meaning. In addition, the term “domain” may include an area of expertise for a system or a collection of material, information, content and/or other resources related to a particular subject or subjects. A domain can refer to information related to any particular subject matter or a combination of selected subjects. Additionally, the domain knowledge of the machine learning component 470 and/or the knowledge graph component 440 may include structured data, such as, for example, knowledge graphs, various models, structured and/or unstructured data.

In one aspect, the machine learning component 470 as described herein, may perform various machine learning operations using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

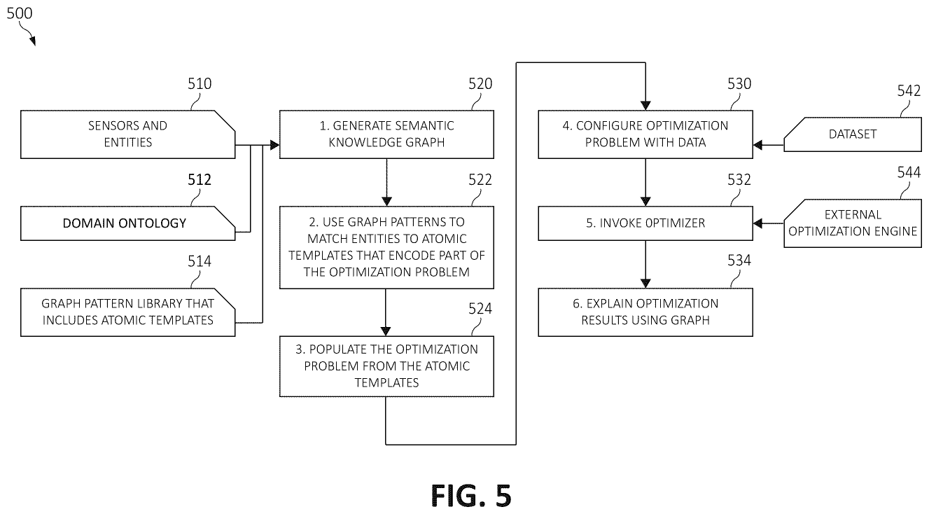

Turning now to FIG. 5, a block-flow diagram of exemplary functionality 500 relating to configuring optimization problems from one or more sources is depicted. As shown, the various blocks of functionality are depicted with arrows designating the blocks' 500 relationships with each other and to show process flow. Additionally, descriptive information is also seen relating each of the functional blocks 500. As will be seen, many of the functional blocks may also be considered “modules” of functionality, in the same descriptive sense as has been previously described in FIG. 4. With the foregoing in mind, the module blocks 500 may also be incorporated into various hardware and software components of a system for identifying relevant graph patterns in a knowledge graph in accordance with the present invention.

As illustrated in FIG. 5, data may be provided (as input data) list of sensors and entities (e.g., system components 510, a domain ontology 512 (e.g., a domain knowledge) including optimization problems relevant to the domain, and graph pattern library 514 (e.g., a library of graph patterns) and associated atomic optimization templates. Each template defines an objective, constraint or action to be added to an optimization problem.

As depicted in block 520, in step 1, a semantic knowledge graph may be generated. In step 2, one or more graph patterns may be used to match entities (e.g., the list of sensors and entities) to one or more atomic optimization templates that encode part of the optimization problem, as in block 522. In step 3, the optimization problem may be populated from the one or more atomic optimization templates, as in block 524.

In step 4, the optimization problem may be configured with data such as, for example, dataset 542, as in block 530. In step 5, an optimizer may be invoked such as, for example, an external optimization engine 544, as in block 532. In step 6, the optimization results may be explained using the semantic knowledge graph, as in block 534.

For example, for each tuple (e.g., graph pattern, template), the present invention may reason on the semantic knowledge graph to select instances that match the graph pattern and their attached properties. For all matches of the graph pattern apply an atomic optimization template and create and configure a template instance and join the template instances with existing optimization problem. A scoring dataset may be prepared, and the optimization problem may be configured from data sources that are connected to the semantic knowledge graph. Potential Data sources and/or external databases may be accessed, and the dataset may be scored using the optimization model. The optimization results may be explained using the semantic knowledge graph.

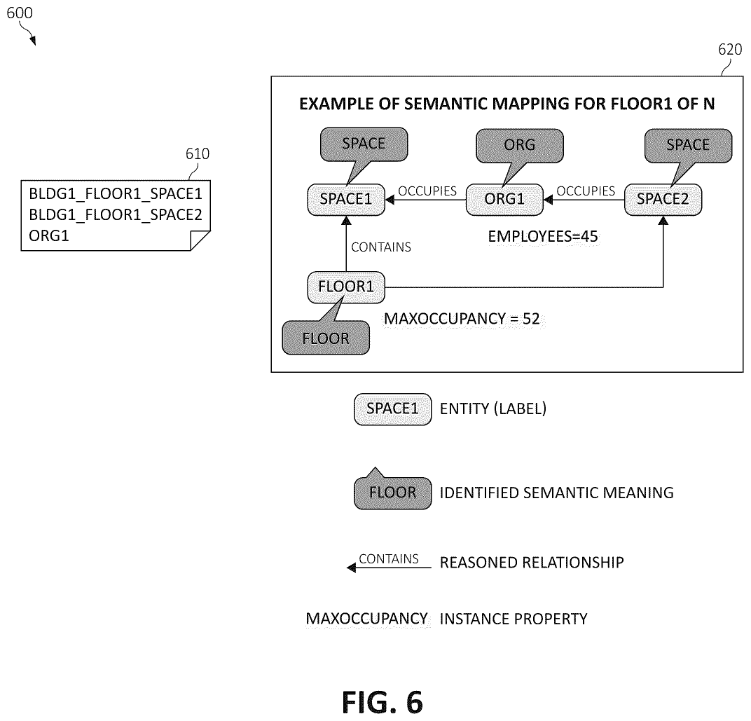

For further explanation, FIG. 6 is a block diagram 600 of a construction of a knowledge graph in accordance with aspects of the present invention. It should be noted that FIG. 6 depict a sample knowledge graph. In one aspect, one or more of the components, modules, services, applications, and/or functions described in FIGS. 1-5 may be used in FIG. 6. As will be seen, many of the functional blocks may also be considered “modules” or “components” of functionality, in the same descriptive sense as has been previously described in FIGS. 1-5.

As depicted in FIG. 6, a list of entities 610 describing, for example, a particular system or entity (e.g., a building that encodes a number of floors and the spaces on each floor, and organizations that occupy those spaces) such as, for example, building 1, floor 1, space 1 (“bldg1_Floor1_Space1), building 1, floor 1, space 2 (“bldg1_Floor1_Space2), and organization 1 (Org1).

A semantic knowledge graph 620 may be created from the list. One or more causal links may be injected/added between one or more sensors using physical knowledge. Labels may be included in the semantic knowledge graph 620 (e.g., Space1 is an entity and label for the space 1). A reasoned relationship is provided in the semantic knowledge graph 620 such as, for example, “floor 1” contains space 1. An instance (e.g., property instance) may be included in the semantic knowledge graph 620 such as, for example, a level or degree of a state (e.g., occupancy is maximized “MaxOccupancy”).

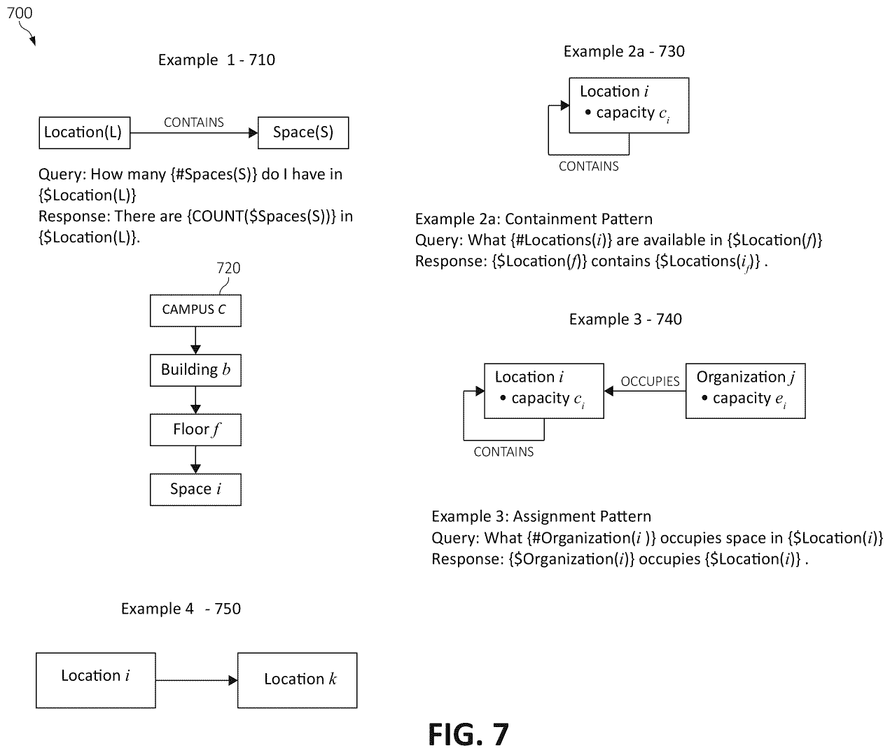

For further explanation, FIG. 7 is an additional diagram 700 applying graph patterns to match entities from the knowledge graph in accordance with aspects of the present invention. In one aspect, one or more of the components, modules, services, applications, and/or functions described in FIGS. 1-6 may be used in FIG. 7. As will be seen, many of the functional blocks may also be considered “modules” or “components” of functionality, in the same descriptive sense as has been previously described in FIGS. 1-6.

As depicted in FIG. 7, three examples (e.g., example 1-4 labeled, 710, 720, 730, 740, and 750, respectively) are depicted for applying graph patterns to match entities from the knowledge graph in accordance.

In some implementations, one or more generic graph patterns may be defined together with respective templates consisting of a question-and-answer response (e.g., a query question/answer response). Within the graph patterns and templates, one or more semantic concepts may be associated in the graph to variables. For example, it should be noted that concepts in the graph may be labeled/noted as “#: and instances with “$” for illustrative purposes only. For example, ‘{$Location(L)}’ in example 1 (e.g., example 610) assigns all instances of concept ‘Location’ to variable ‘L’. While ‘{#Space(S)}’ (e.g., Spaces(S) assigns all sub-concepts of ‘Space’ to variable ‘5’. For example, query: how many {#Spaces(S)} do I have in {$location(L)}? Response: There are {count($Spaces(S))} in {$location(L)}.

The graph patterns may be applied to the graph to select potential instances for use in the optimization problem.

In example 2 (e.g., example 720), a containment pattern may be used to identify any location that is a sublocation of another. The result is used to identify a set of target spaces {$Spaces(i)} that are available at a specified location. For example, containment pattern: query: What {#Spaces(S)} are available in {$Floor(f)}? Response: {$Floor(f)} contains in {#Spaces(i_{f})}.

In example 2a, (e.g., example 730), another version of the containment pattern is depicted that takes advantage of subsumption in the knowledge graph to identify all Locations {$Location(i)} that are contained at a specified Location. The properties of individual instances can also be extracted from the graph using the graph patterns. For example, consider a set of spaces identified using the containment pattern in example 2a. Each space has a capacity property. This property can be selected from the entities matched by the graph pattern, yielding a set of capacities {$Capacitiy(c!)}. For example, containment pattern: query: What {$Location(i)} are available in {$location(f)} ? Response: {$location(f)} contains {$Locations(i f)}.

In example 3, (e.g., example 740), an assignment pattern is depicted that identifies the set of organizations {$Organization(j)} that occupy spaces in a location Individual organizations may have properties for the number of employees of the organization, a seat allocation budget etc. As before a set of properties {$Employees(e!)} can be populated from the entities that are matched by the graph pattern. For example, containment pattern: query: What {$Organization(j)} occupies space in {$location(i)}? Response: {$Organization(j)} occupies {$Location(i))}.

In some implementations, the present invention may configure one or more atomic optimization templates. Graph patterns may be associated with the atomic optimization templates that encode part of an optimization problem and capture objectives, constraints and weights that can be applied to the larger optimization problem. For example, by way of illustration purposes only, using a set of spaces and organizations identified in the example 2 and example 3, one or more decision variables xᵢⱼ may be specified that indicates if a space i is assigned to an organization j. Together these can be used to populate an objective function for an optimization problem, e.g., to maximize the allocation of spaces across organizations. For example, an objective may be to maximize allocation of locations to organizations using the sets of {$Location(i)} and {$Organization(j)}, which may use equation 1:

maxₓΣᵢⱼxᵢⱼ (1),
One or more constraints may be applied to the objective function using the properties of the matched entities; e.g., the capacity property of the matched spaces can then be used as a constraint in the optimization problem, or the number of employees of an organization is used to constrain the allocation of spaces to that organization.

In some implementations, a constraint may be used such as, for example, using a set of {$Capacity(cᵢ)}, where each location (i) can be allocated only up to its capacity cᵢ as illustrated in equation 2:

Σⱼxᵢⱼ≤cᵢ∀i (2),

In some implementations, a constraint may be used such as, for example, using the set of {$Employees(eⱼ)}; an organization (j) cannot be allocated more spaces than it has employees eⱼ as illustrated in equation 3:

Σᵢxᵢⱼ≤eⱼ∀j (3).

In addition, one or more additional constraints and modifications may be introduced/added to the objective function by applying additional graph patterns and associated atomic optimization templates. For example, in example 4 (e.g., example 750), a graph pattern introduces a distance pattern that can be used to add a social distant constraint to the problem. A distance (D) pattern may be used to query the graph for pairs of locations {($Location(i), $Location(k)} that are separated by a distance less than or equal to distance D. This can then be used to configure an optimization constraint to ensure that spaces withing social distance of each other are not both selected. In some implementations, a constraint may be used such as, for example, using only one of {($Location(i), $Location(k)} can be allocated as illustrated in equation 4:

I={(i,k):dᵢₖ<D,i<k},

yᵢ=Σⱼxᵢⱼ∀i,

yᵢ+yₖ≤1∀(i,k)∈I (4),

For example, for distances between locations: query: {#Location(i)} distance to {#Location(k)}<=D: Response: {($Location(i), $Location(k)) have dᵢₖ<=D}.

Example 5 may illustrate how the Assignment Pattern is used to query the graph for a set of locations and organizations that occupy those resources. The result may be used to create a set of binary variables ( [symbol] ) that represent an existing seat allocation to be used in the optimization problem. An action may apply a weight C to an existing allocation {($Organization(j),{$Location(i)}) in the objective function, as illustrated in equation 5:

Objective+=C*abs( [symbol] −xᵢⱼ)∀i∈Ĩ,∀j∈\tilde{J} (5),

For example, for an assignment Pattern (see also example 3): Query: What {#Locations(i)} are occupied by {$Organization(j)} in {$Location(f) and Response: {$Organization(j)} occupies {$Location(i)}.

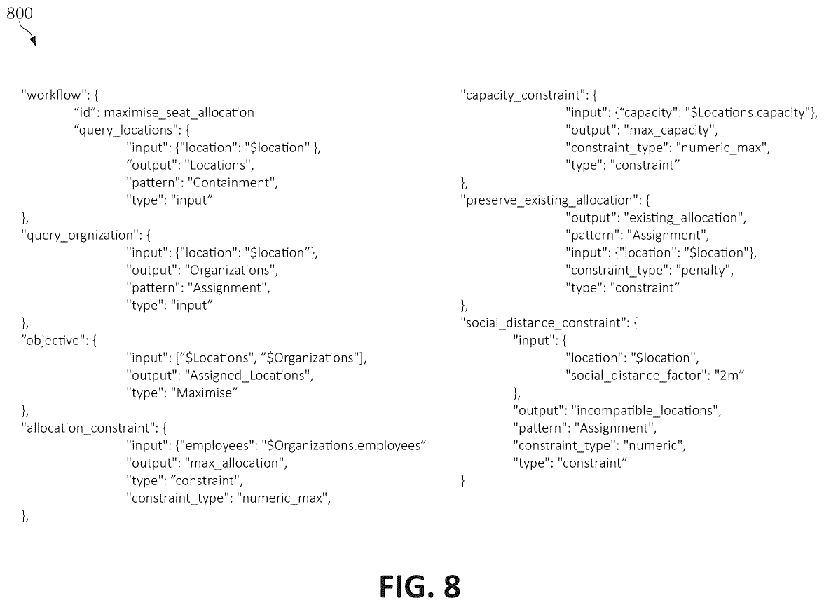

FIG. 8 is an additional block diagram 800 illustrating an example of a resulting pipeline configuration of the optimization problem in accordance with aspects of the present invention in accordance with aspects of the present invention. In one aspect, one or more of the components, modules, services, applications, and/or functions described in FIGS. 1-7 may be used in FIG. 8. As will be seen, many of the functional blocks may also be considered “modules” or “components” of functionality, in the same descriptive sense as has been previously described in FIGS. 1-7.

As depicted in FIG. 8, consider the pseudo code for composing an optimization problem by a generator combining matched entities and configured templates from the previous steps and composes them into an optimization problem. The optimization problem may be described as a workflow consisting of a set of steps, each of which maps to an existing graph pattern, and associated template. A workflow for combining the objectives, constraints and actions illustrated in the previous slides “maximize seat allocation” workflow as depicted in FIG. 8.

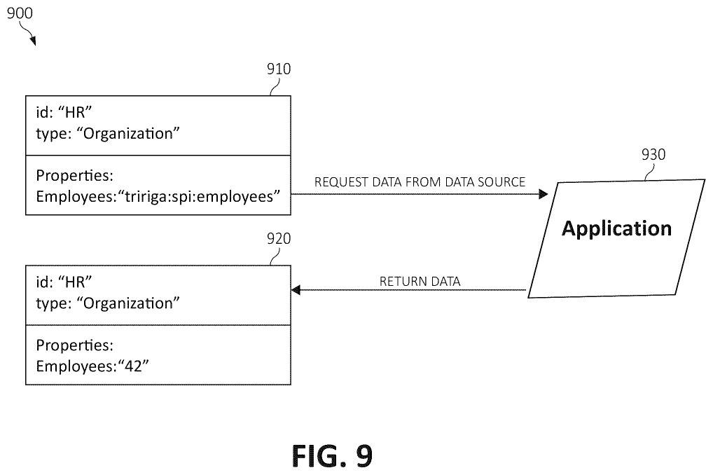

FIG. 9 is an additional block diagram adding additional data in accordance with aspects of the present invention. In one aspect, one or more of the components, modules, services, applications, and/or functions described in FIGS. 1-8 may be used in FIG. 9. As will be seen, many of the functional blocks may also be considered “modules” or “components” of functionality, in the same descriptive sense as has been previously described in FIGS. 1-8.

As depicted in FIG. 9, as required, a generator may ingest data from external data sources 910, 920 connected to the knowledge graph. These data sources 910, 920 can include SQL and not only SQL (“NoSQL) databases as well as external systems that such as, for example, application 930 (e.g., a company's real estate application suite such as, for example IBM® TRIRIGA® “tri”)). Data in external data sources may be identified using a key. For example, employees property {(e #)} for an organization (j) may be represented by “p: {employees: “tri:spi:employees”}” where the key “tririga:spi:employees” indicates that the value needed for the property is stored in an associated application 930 (e.g., IBM® TRIRIGA® system).

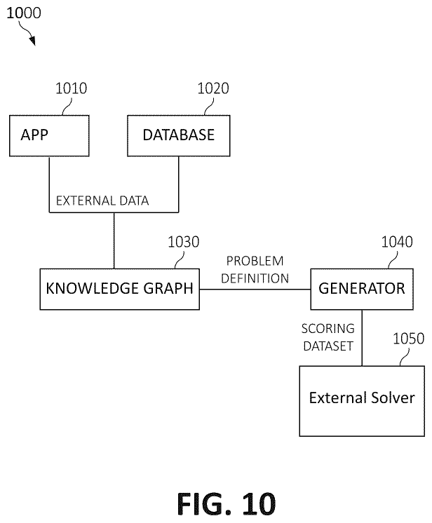

FIG. 10 is an additional block diagram using an external solver to run a model in accordance with aspects of the present invention. In one aspect, one or more of the components, modules, services, applications, and/or functions described in FIGS. 1-9 may be used in FIG. 10. As will be seen, many of the functional blocks may also be considered “modules” or “components” of functionality, in the same descriptive sense as has been previously described in FIGS. 1-9.

As depicted in FIG. 10, an external solver 1050 may be is used to score the optimization problem generated from the knowledge graph. As depicted in block 1010 and 1020, the specific dataset to be scored is collected from a database, API or another data store (e.g., database 1020, app 1010, etc.). A knowledge graph 1030 may be create, generated, and/or used from that data. A generator 1040 may use a problem definition from the knowledge graph 1030 to provide a problem definition and a scoring dataset. The final optimization problem may be solved locally or by an external solver 1050.

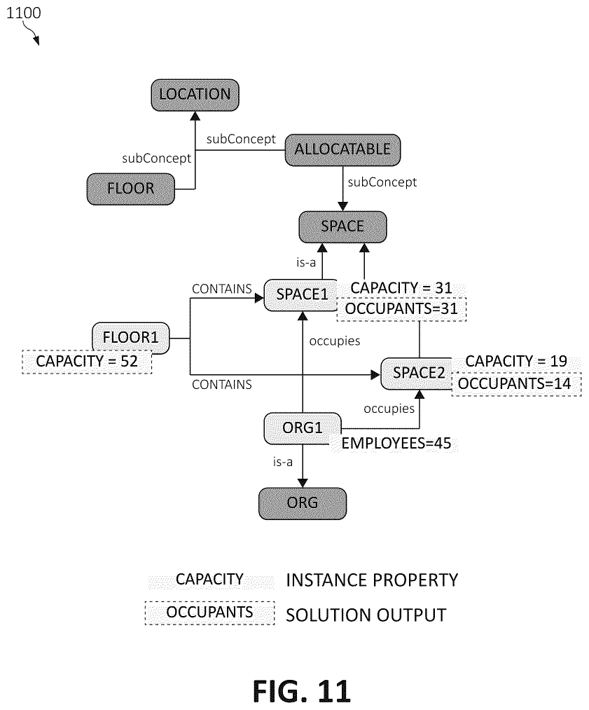

For further explanation, FIG. 11 is an additional block diagram explaining optimization results using a knowledge graph in accordance with aspects of the present invention. In one aspect, one or more of the components, modules, services, applications, and/or functions described in FIGS. 1-10 may be used in FIG. 11. As will be seen, many of the functional blocks may also be considered “modules” or “components” of functionality, in the same descriptive sense as has been previously described in FIGS. 1-10.

As illustrated in FIG. 11, based on the automatically configured optimization workflow (e.g., FIG. 10), an optimized solution may be provided. The optimized solution describes a new state to be applied to the graph such as, for example a query may be: Query: What is the optimal allocation of employees to Floor 1. The response/answer may be: Answer: optimal occupancy is 31 occupants in space 1, 14 occupants in space 2. Constraints may be: Employees of Org1, Capacity of space 1, Capacity of space 2. In one aspect, an instance property may be the capacity and the solution output may be the occupants.

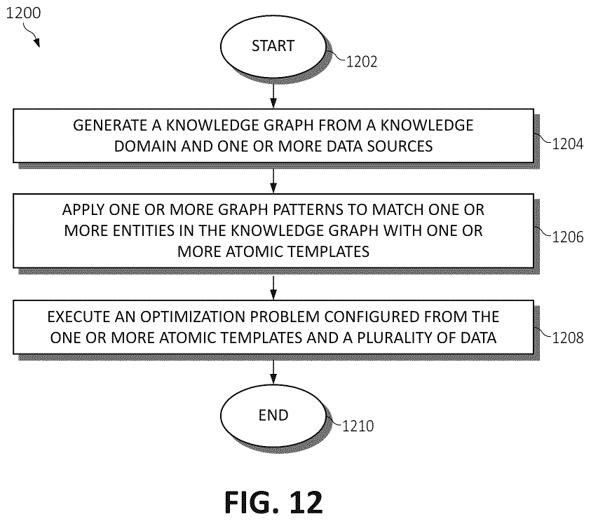

Turning now to FIG. 12, a method 1200 for configuring optimization problems from one or more sources in a computing environment is depicted, in which various aspects of the illustrated embodiments may be implemented. The functionality 1200 may be implemented as a method executed as instructions on a machine, where the instructions are included on at least one computer readable medium or one non-transitory machine-readable storage medium. The functionality 1200 may start in block 1202.

A knowledge graph may be generated from a knowledge domain and one or more data sources, as in block 1204. One or more graph pattens may be applied to match one or more entities in the knowledge graph with one or more atomic optimization templates, as in block 1206. An optimization problem configured from the one or more atomic optimization templates and a plurality of data may be executed, as in block 1208. The functionality 1200 may end, as in block 1210.

In one aspect, in conjunction with and/or as part of at least one block of FIG. 12, the operation of 1200 may include each of the following. The operation of 1200 may identify the one or more entities in the knowledge graph using the one or more graph patterns and reasoning data, wherein the one or more graph patterns are predefined.

The operation of 1200 may populate the one or more atomic optimization templates with the one or more entities; and configure an atomic subset of the optimization problem with the one or more entities.

The operation of 1200 may compose the optimization problem using the one or more entities identified in one or more optimization pipelines in the knowledge graph, wherein data linked to the knowledge graph is used to formulate the optimization problem. The operation of 1200 may provide an optimized solution upon executing the optimization problem.

The operation of 1200 may configure an optimization problem using the one or more atomic optimization templates of a plurality of data. The operation of 1200 may provide an explanation of results generated from executing the optimization problem.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by a processor, for configuring optimization problems from one or more sources, comprising:
generating a knowledge graph from a knowledge domain and one or more data sources;
applying one or more graph pattens to match one or more entities in the knowledge graph with one or more atomic optimization templates; and
executing an optimization problem configured from the one or more atomic optimization templates and a plurality of data.

2. The method of claim 1, further including identifying the one or more entities in the knowledge graph using the one or more graph patterns and reasoning data, wherein the one or more graph patterns are predefined.

3. The method of claim 1, further including:
populating the one or more atomic optimization templates with the one or more entities; and
configuring an atomic subset of the optimization problem with the one or more entities.

4. The method of claim 1, further including composing the optimization problem using the one or more entities identified in one or more optimization pipelines in the knowledge graph, wherein data linked to the knowledge graph is used to formulate the optimization problem.

5. The method of claim 1, further including configuring the optimization problem using the one or more atomic optimization templates and the plurality of data.

6. The method of claim 1, further including providing an optimized solution upon executing the optimization problem.

7. The method of claim 1, further including providing an explanation of results generated from executing the optimization problem.

8. A system for configuring optimization problems from one or more sources in a computing environment, comprising:
one or more computers with executable instructions that when executed cause the system to:
generate a knowledge graph from a knowledge domain and one or more data sources;
apply one or more graph pattens to match one or more entities in the knowledge graph with one or more atomic optimization templates; and
execute an optimization problem configured from the one or more atomic optimization templates and a plurality of data.

9. The system of claim 8, wherein the executable instructions when executed cause the system to identify the one or more entities in the knowledge graph using the one or more graph patterns and reasoning data, wherein the one or more graph patterns are predefined.

10. The system of claim 8, wherein the executable instructions when executed cause the system to:
populate the one or more atomic optimization templates with the one or more entities; and
configure an atomic subset of the optimization problem with the one or more entities.

11. The system of claim 8, wherein the executable instructions when executed cause the system to compose the optimization problem using the one or more entities identified in one or more optimization pipelines in the knowledge graph, wherein data linked to the knowledge graph is used to formulate the optimization problem.

12. The system of claim 8, wherein the executable instructions when executed cause the system to provide an optimized solution upon executing the optimization problem.

13. The system of claim 8, wherein the executable instructions when executed cause the system to configure an optimization problem using the one or more atomic optimization templates of a plurality of data.

14. The system of claim 8, wherein the executable instructions when executed cause the system to provide an explanation of results generated from executing the optimization problem.

15. A computer program product for configuring optimization problems from one or more sources in a computing environment, the computer program product comprising:
one or more computer readable storage media, and program instructions collectively stored on the one or more computer readable storage media, the program instruction comprising:
program instructions to generate a knowledge graph from a knowledge domain and one or more data sources;
program instructions to apply one or more graph pattens to match one or more entities in the knowledge graph with one or more atomic optimization templates; and
program instructions to execute an optimization problem configured from the one or more atomic optimization templates and a plurality of data.

16. The computer program product of claim 15, further including program instructions to identify the one or more entities in the knowledge graph using the one or more graph patterns and reasoning data, wherein the one or more graph patterns are predefined.

17. The computer program product of claim 15, further including program instructions to:
populate the one or more atomic optimization templates with the one or more entities; and
configure an atomic subset of the optimization problem with the one or more entities.

18. The computer program product of claim 15, further including program instructions to:
compose the optimization problem using the one or more entities identified in one or more optimization pipelines in the knowledge graph, wherein data linked to the knowledge graph is used to formulate the optimization problem; and
provide an optimized solution upon executing the optimization problem.

19. The computer program product of claim 15, further including program instructions to configure an optimization problem using the one or more atomic optimization templates of a plurality of data.

20. The computer program product of claim 15, further including program instructions to provide an explanation of results generated from executing the optimization problem.
